(19) United States
(12) Patent Application Publication
(10) Pub. No.: US 2011/0256521 A1
(43) Pub. Date: Oct. 20, 2011

(54) METHOD AND APPARATUS FOR CUSTOMIZING LESSON PLANS

(75) Inventors: Renee C. Mansfield, Uxbridge, MA (US); Katherine E. Foster, North Easton, MA (US); Utah Way Nickel, Holliston, MA (US); Leonard Vincent Strully, JR., Boston, MA (US)

(73) Assignee: The New England Center for Children, Inc., Southborough, MA (US)

(21) Appl. No.: 13/115,645

(22) Filed: May 25, 2011

Related U.S. Application Data
(63) Continuation-in-part of application No. 10/991,133, filed on Nov. 17, 2004, now Pat. No. 7,974,569.

(51) Int. Cl. G09B 7/00

(52) U.S. Cl. 434/350; 434/362

(57) ABSTRACT

The present invention relates to a computer system that customizes lesson plans of students and reports the outcome of the same. In one example embodiment, a collection and aggregation module, coupled to a computer memory, collects current student record data of a plurality of students and aggregates the collected student record data over time and over various pluralities of students to generate a superset aggregate data. The student record data includes recent performance and progress data for each student. A curriculum customization module receives the superset aggregate data from the collection and aggregation module and customizes a current curriculum for a given student using the superset aggregate data.

### RELATED APPLICATIONS

This application is a continuation-in-part of U.S. application Ser. No. 10/991,133, filed Nov. 17, 2004. The entire teachings of the above application are incorporated herein by reference.

### BACKGROUND

In the field of education, general lesson plans are used to guide a teacher's classroom instruction. In public schools or government-funded education programs, a state department defines the standards and curriculum guidelines to be followed. At the next level down in the education system, the local administration/board of education specifies age appropriate curriculum and particulars that meet the state minimum standard guidelines. Each teacher then creates lesson plans that satisfy the curriculum set forth by the local administration.

In specialized school programs, lesson plans need to be customized per student, and if the school program is federally funded, lesson plans need to meet governmental requirements in terms of curriculum standards. Each student who is eligible for special education services is required to have an Individual Education Program (IEP). An example of such customization is at a publicly-funded school for learning disabled children. Although there are state and federal guidelines, there is a lack of curriculum for carrying out said guidelines.

Further, for a given student, there is added administrative/reporting overhead in creating customized lesson plans. This is compounded across different students where a school customizes lesson plans for each student and no two students have the same set of lesson plans. There is a need for an improved process of customizing lesson plans of students and reporting of the same.

Generally speaking, automated systems for generating lectures or lesson plans exist. Examples are:
U.S. Pat. No. 5,601,436 to Sudman et al.,
U.S. Pat. No. 6,516,340 to Boys,
U.S. Pat. No. 6,533,583 to Sportelli,
U.S. Pat. No. 6,537,073 to Zhang,
U.S. Patent Application No. 2003/0236796 to Easter et al.,
U.S. Patent Application No. 2004/0081953 A1 to Murphy,
U.S. Patent Application No. 2004/0107413 A1 to Bixler, and
“Lesson Plan Generator” and other educator products by Canela Software (see Canela Software.com website).

However, none of these systems are specific to any certain type of student or learning disability and none address student specific (or custom per student) lesson planning. In addition, these systems do not guide a teacher through assessment, customization per individual student and/or reporting.

Since, in specialized teaching programs, lesson plans need to be customized to meet the educational needs of each student, government funded schools are required under the Individuals with Disabilities Education Act (IDEA) to develop an Individualized Education Plan (IEP) for every student with a disability who meets the government requirements for special education. Although various techniques for preparing an IEP are currently available, there is a need for providing individuals with disabilities with lesson plans directed to “whole person development” in various domains, in a manner that allows for varying rates of learning across the domains. Domains include academics, personal health/wellbeing and social development.

Further, The IEP for each student needs to be monitored to ensure that it meets the needs of each student as the student progresses within in each domain area of learning. Educational entities may also be interested in monitoring teaching related parameters such as overall effectiveness of lesson plans, individual teacher performance, student group performance, research outcomes and etc. As such, there is a need for an improved system that customizes lesson plans of students and reports the outcome of the same.

### SUMMARY

The present invention provides a method and system that overcomes the problems of the prior art. The present invention especially addresses individuals with autism or similar learning profiles in which the individual learns skills in one area at different rates than skills in other areas. This is known as “splinter skills”. In particular, the present invention enables the generation of lesson plans that are individualized (or customized) per student and that address the development of the whole person (socially, emotionally, physical health/hygiene wise, etc. . . . as well as academically) from childhood to adulthood. To accomplish this, the lesson plans of the present invention teach various sets of skills in the areas of communication, academics, social skills, leisure/recreation, vocational, self help, health and behavior to decrease (i.e., maladaptive behavior to reduce). These category areas are herein termed “domains”.

For a given domain, there are respective sets of age appropriate skills (e.g., one set of skills for children, another set of skills for adults, etc.). In a preferred embodiment, the present invention identifies a core set of skills, in each domain, necessary for independent functioning of the student. This depends, in part, on the age of the student and on the development level of the student in the subject domain. Different lesson plans assist with the development of different skills in the subject domain. For a given skill, a series of lesson plans provide introduction, practice and mastery of the skill. Thus the lesson plans of the present invention teach a skill along a continuum from teaching prerequisite skills to mastery of the skill at the appropriate age level.

Accordingly, the domains, corresponding sets of skills and continuum series of lesson plans of the present invention enable teachers and administrators alike to create individualized, growth and development programs for learning disabled individuals. In particular, the present invention recognizes that the individual with autism may learn different skill areas at different rates. For example, an autistic student may have a third grade reading ability but does not know how to tie his shoes. Thus the present invention is directed to whole person development from preschool to adulthood topics (lessons) in each of the domains but in a manner that allows for varying rates of learning across the domains (accommodates different rates in different domains).

In one embodiment, computer apparatus of the present invention includes a curriculum data store, a student information module and a processor routine coupled to the curriculum data store and student information module. Each record in the curriculum data store indicates a respective teaching activity with implementation details (step by step instructions) for use as part of a lesson plan. Alternative implementations with corresponding step by step instructions for carrying out the teaching activity are also indicated.

The student information module provides, for each student, indications of assessed skill level in each domain area and learning profile (including historical development/learning pattern and observed preferences). In a preferred embodiment, an initial skill assessment and on-going assessments are employed in forming the student's assessed skill level. Indications of student performance across past and current lesson plans and student performance within each teaching session (trial) provide a running history of skill development of the student in the student information module.

The processor routine determines, for a subject student, a subset of teaching activities in the curriculum data store as a function of assessed skill level per domain area of the subject student as indicated by the student information module. The processor routine enables an educator-user to select at least one of the teaching activities from the determined subset and generates therefrom a custom lesson plan for teaching the subject student.

Further, the processor routine enables the educator-user to view student information (e.g., learning profile, history of skill development, etc.) of a given student during selection of a curriculum record (teaching activity) from the curriculum data store in generating custom lesson plans for a student. Thus, the present invention enables the educator-user to be guided by the student information when selecting among teaching activity implementation alternatives for lesson plans. That is, the present invention enables the educator-user to make a determination of which implementation best suits the given student's learning preference (or style) per domain area. Such provides highly customized and individualized lesson plans per student where the generated custom lesson plan for the student includes the implementation of the teaching activity that the educator-user has selected as best matching the student's learning profile.

A method and corresponding apparatus according to an example embodiment of the present invention relates to a computer system that customizes a curriculum of a student. The computer system includes a collection and aggregation module and a curriculum customization module. The collection and aggregation module is coupled to the computer memory and is configured to collect current student record data of a plurality of students. The student record data includes recent performance and progress data for each student. The collection and aggregation module is configured to aggregate the collected student record data over time and over various pluralities of students to generate a superset aggregate data. The curriculum customization module is configured to receive the superset aggregate data from the collection and aggregation module and customize a current curriculum for a given student as a function of the superset aggregate data.

The computer system may collect the current student record data at predetermined time intervals. The student record data may include at least one of curriculum data, student course status data, personal student data, teacher data, and group data. The student course status data may include at least one of teaching procedures, research data, student progress, and time elapsed since application of a teaching procedure. The personal student data may include at least one of student's performance, behavior assessment, skill assessment and age. The teacher data may include experience level. The group data may include at least one of group performance and student's personal performance versus group performance.

The computer system may include a data module that collects research data and updates the superset aggregate data as a function of the collected autism research data. The computer system may include a reporting module, coupled to the memory, that generates data reports for the student. The curriculum customization module customizes the curriculum for the given student as a function of updated teaching procedures used.

The computer system may include a synchronization module that synchronizes the superset aggregate data and autism research data. The synchronization module may be configured to generate synchronized student record data as a function of synchronizing the current student record data with the superset aggregate data.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic illustration of a computer network environment in which embodiments of the present invention may be practiced.

FIG. 2 is a block diagram of a computer from one of the nodes of the network of FIG. 1.

FIGS. 3a-3b illustrate a curriculum sheet used by the teacher to carry out a day's lesson or exercise unit.

FIGS. 4a-4b are flow diagrams of one embodiment of the present invention software with respect to a teacher-user.

FIG. 5 is a flow diagram of the embodiment of FIGS. 4a-b with respect to an administrator-user.

FIG. 6 is an illustration of a table of a student record in the embodiment of FIGS. 4a and 4b.

FIG. 7A is a block diagram of an example embodiment of a data analysis and reporting tool.

FIG. 7B is a high-level illustration of a data analysis and reporting tool according to an example embodiment of the present invention.

FIG. 8 is an example illustration of a management module that may be used with the techniques described herein.

FIG. 9 is an illustration of student record data according to an example embodiment of the present invention.

FIG. 10 is a high-level illustration of a data management module and a data collection and aggregation module according to an example embodiment of the present invention.

FIG. 11 is a schematic view of a sample aggregate report for a student in an example embodiment.

FIG. 12 is a high-level illustration of a reporting module according to an example embodiment of the present invention.

FIG. 13 is a high-level illustration of a data collection and aggregation module according to an example embodiment of the present invention.

### DETAILED DESCRIPTION

A description of example embodiments of the invention follows.

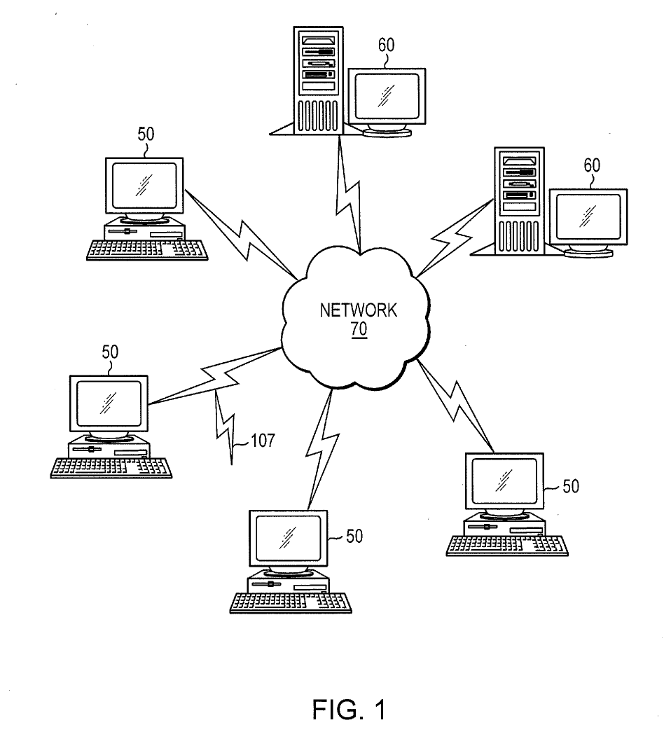

FIG. 1 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

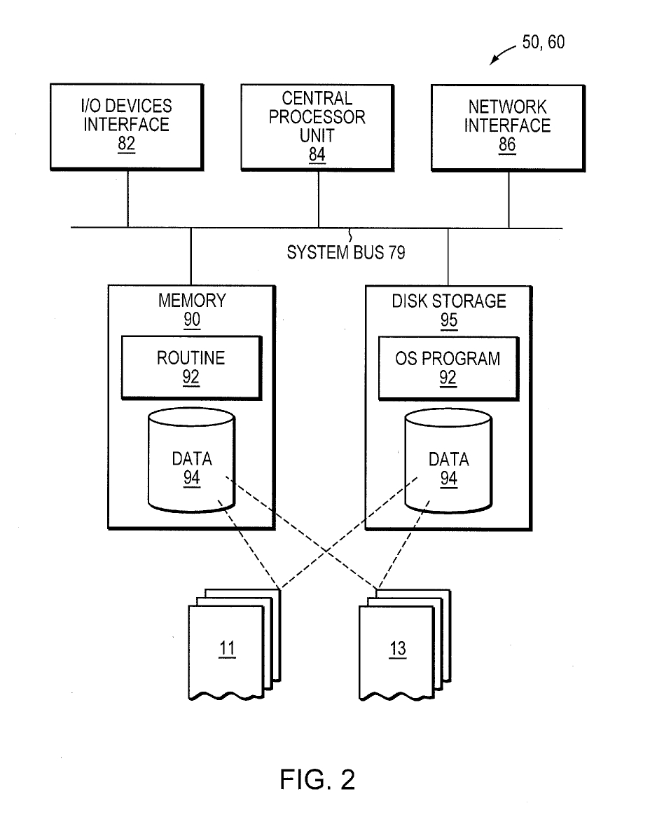

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions used to implement an embodiment of the present invention (e.g., Program Routines 92 and Data 94, detailed later). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

In the preferred embodiment, data 94 includes student records 11 and a curriculum data store formed of a set 13 of teaching activities for incorporating into lesson plans. Both the student information of the student records 11 and the teaching activities of curriculum records 13 are organized according to the present invention domain areas of communication, academics, social skills, leisure/recreation (generally fitness), vocational, self help, health and behavior to reduce. For each domain area, there is a predefined set of skills, a subset of which are a core set of skills that Applicants have identified as necessary for independent functioning.

An example of the skills in the communication domain includes: expressive language, expressive vocabulary, receptive language, receptive vocabulary, skills for following directions and the like. Core skills for the communication domain preferably include: requesting items; gaining attention; making choices among visually presented items; requesting to stop; stating yes/no; requesting help; following directions; one-step directions; responding to “stop”/“come”; following instructions from a distance; responding to name; receptive identifying of body parts, objects, pictures, familiar people and objects; using expressive vocabulary; expressive identifying of objects, pictures, familiar people and objects.

An example of the skills in the academics domain includes: math, spelling, reading, etc. Core skills include: attending to the speaker; matching objects, photos/pictures, picture to object and object to picture; discriminating; and scanning and looking.

An example of the skills in the self-help domain includes: domestic cleaning, hygiene maintenance skills, dressing oneself, eating skills and the like. Core skills include: dressing, washing, showering, tooth brushing, chewing food, eating with utensils, eating various foods, drinking from a cup, toileting, stopping when directed, exiting given a fire alarm, wearing a seat belt (riding in car/vehicle), tolerating medical procedures, taking medication and identifying self.

An example of the skills in the leisure/recreation domain includes: exercise, community recreation, hobbies, etc. Core skills include: gross motor, walking independently, exercising, walking in the community, following a schedule (picture schedule, written schedule), age appropriate leisure skills and leisure activities.

An example of the skills in the vocational domain includes: custodial, clerical, food service, etc. Core skills include: maintaining appropriate appearance and greeting others.

An example of the skills in the social skills domain includes: appropriate behavior, social interaction and reducing maladaptive behavior. Core skills include: increasing appropriate social behavior, compliance, waiting, choice making, using functional language alternatives, establishing preferences, using conditioned reinforcers, decreasing inappropriate social behavior, social/sexual behavior, privacy (personal hygiene, sexual behavior, personal space), eye contact (in response to name, while engaged in activity, from a distance and during group instruction), group participation, imitation, one-step gross motor, actions with objects, sequenced gross motor, sequenced actions with objects, and age related independent play.

An example of the skills in the health domain includes: safety, growth and development and physical fitness. Core skills include: tolerating medical procedures and personal privacy.

Students are assessed on the core set of skills per domain area and lesson plans are made according to assessed skill level as will be further discussed below. Preferably an initial assessment and ongoing assessments are utilized with assessment results indicated or otherwise recorded in student records 11. Assessment results may include comments by parents, government worker input/feedback and the like in addition to educators. In one embodiment, the student records 11 are formed and formatted as follows.

For a given student, the corresponding student record 11 has (a) a general information section, (b) a lesson (past and current) tracking section, (c) a skill level section and (d) a learning profile portion. The general information section provides the student's name, age, address and other general information. The lesson tracking section provides summaries of both past and current lessons. For past lessons, a lesson history section is arranged chronologically and sets forth descriptions of lessons (including curriculum content, teaching activities or exercises), corresponding performance outcome of each lesson session or trial (e.g., skill introduced, skill mastered, . . . ), number of times the lesson/teaching activity was repeated before the skill was mastered, and the like.

The skill level section of a student record 11 provides an indication of assessed skill level (from the initial and ongoing assessments by educators) in each domain area. That is for a given domain, this section of the student record 11 indicates skill development level in each of the skills of the core set of skills in the domain. Preferably, skill development level is indicated along a continuum or range, for example, skill introduced, skill practiced and skill mastered. As such, the present invention enables, per student, identification of which core skills need what level of attention (introduction, practice and/or mastery) in each domain.

The learning profile portion of a student record 11 includes indications of student preferences (as observed by educators), learning patterns, past performance, techniques liked or disliked by the student and similar information, in general or per domain. These aspects and indications are especially helpful in teaching individuals with autism or students with learning disabilities.

The data set (records) 13 of teaching activities in the preferred embodiment is referred to as a curriculum data bank 13. As mentioned above, the curriculum records (teaching activities) 13 are organized or categorized by domain. For each domain, there is a respective age appropriate set of skills to be taught to and/or mastered by the student. Thus curriculum/activity records 13 are further subcategorized by applicable age.

For each of the different skills, the curriculum records/data store 13 provide teaching activities that introduce the skill, teaching activities that practice or develop the skill and teaching activities that assist with mastering the skill. For example, introductory teaching activities for expressive language skills in the communications domain may be (1) obtaining the student's attention, (2) vocal imitation and (3) following a point by looking at an item. An example activity of the next level of development of the expressive language skills may be orally naming objects in the environment to express identification of objects. The sets of skills and activities directed to the same meet government curriculum standards and industry best practices and standards. More importantly, the teaching activities and corresponding sets of skills across the various domains address development of the “whole person” from preschool to adult stages unique to the present invention.

Preferably there is one teaching activity per record 13, and the record provides step by step instructions for implementing or carrying out the teaching activity. The step by step instructions follow best practices and industry approved methodologies (such as using principles of Applied Behavior Analysis in the case of autistic students). Alternative implementations for the subject teaching activity may also be provided. For example, a record 13 provides step by step instructions for teaching a student to drink from a cup. The standard step by step instructions use visual modeling. The alternative implementation in the record 13 provides step by step instructions that use manual guidance. A third implementation for the subject teaching activity/record 13 provides step by step instructions based on another technique approved in the industry.

In addition to skill development level (introductory, practice, mastery), the teaching activities/records 13 within the curriculum data bank may be further sub-categorized by level of abstractness. For example, in the set of records 13 that provide teaching activities for obtaining adeptness of a skill, there are some records that provide teaching activities which enable a more abstract grasp of the skill (less tied to environment or context). The teaching activities which provide the skill independent of environment or context may be considered to be more difficult and reserved for the mastery stage of learning the skill. Level of abstraction and environmental or contextual influence are unique to teaching individuals with autism and individuals with certain learning disabilities.

In the preferred embodiment, respective relational databases are used to implement the data store of student records 11 and the curriculum data bank 13. A portable programming language such as Javascript or other programming language may be employed. The curriculum data store records 13 are indexed by domain, applicable age, core skill and skill development level. The student records 11 are configured to provide (a) assessed skill level per core skill, per domain and (b) age of student, in a manner that enables cross correlation (query) into the curriculum data store/records 13 to extract pertinent teaching activities records 13. Further, the teaching activities/curriculum records 13 within a same core skill and same development level may be serially or hierarchically ordered (for example by linked lists, or the like). Similar ordering across development levels (from an introductory series of teaching activities to the practice series of activities to the mastery series of a given skill) may be employed. Likewise ordering or sequencing of skills (and hence corresponding teaching activities) within a domain may be employed. Such addresses the sequence of skills to be taught specific to certain learning disabilities like autism.

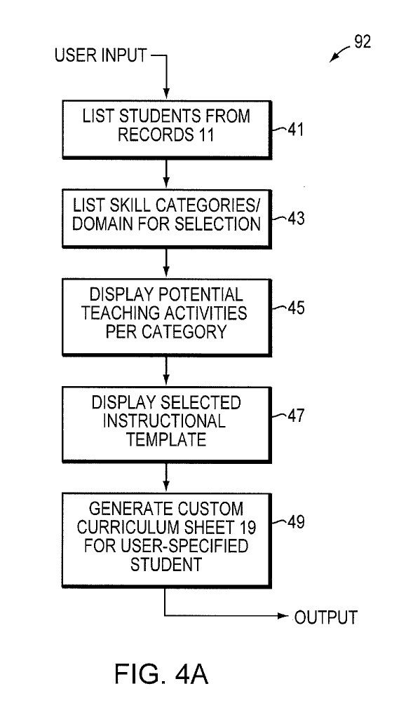

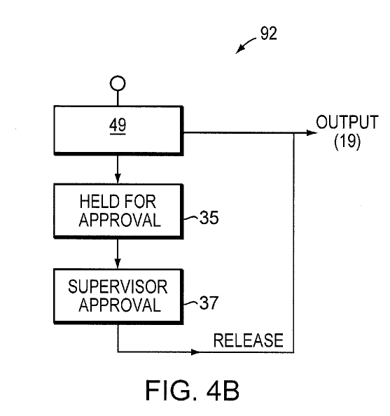

Returning to FIGS. 1 and 2, the present invention computer system 50, 60 provides a tool for an educator to custom design lesson plans for each given student. The flow of computer program 92 control supporting the tool during educator-user use is outlined in FIG. 4a and discussed next. The tool (via computer program/processor routine 92, step 41) displays a list of student names from student records 11. From that list, the educator-user selects a particular student from the data store of student records 11.

Next at step 43, invention routine 92 enables the educator to select a domain (skill set) to be addressed in the current lesson plans being formulated for the subject student. Based on the selected domain, the invention routine 92 looks up the student's assessed skill level in each of the identified core skills for that domain as stored in the subject student's record 11. Routine 92 displays the identified core skills (in the selected domain) for the subject student. Upon user selection or indication of one of these core skills to be addressed in the current lesson plan, processor routine 92 at step 45 obtains various skill development level appropriate and age appropriate activities (records) from the curriculum data bank 13.

Next, invention routine 92 displays or otherwise provides a list or set of pertinent teaching activities from the obtained curriculum records 13, from which the educator-user may make a selection. The invention routine 92 displays prerequisites of a selected teaching activity, step-by-step implementation instructions and an indication of materials for implementing the activity, as well as criteria for progressing with the activity or increasing/decreasing level of the activity.

Here the educator-user may read/review, from the lesson history section of the selected student record 11, the student's prior lessons attempted and accomplished. The educator-user may also read/review from student records 11 the learning profile (learning preferences) of the subject student. With such information at the educator-user's fingertips, the educator-user may more easily determine which implementation alternative (of the selected teaching activity 13) is more suitable (a best fit) for the subject student. Following the prior example of the teaching activity record 13 in which one implementation uses visual modeling and an alternative implementation uses manual guidance, the educator-user may see from the student's record 11 (learning profile and lesson history sections) that the subject student had success in mastering a skill in another domain when manual guidance was used. Thus the educator-user may select the alternative implementation with manual guidance for the current teaching activity record 13. In this way, the lesson plan being currently formulated with selected teaching activity record 13 is customized/individualized for the subject student based on recorded past performance and learning profile.

Further, from the lesson history section of the subject student record 11, the educator-user can see that the subject student has, for example, completed one or many introductory activities, i.e., exercises/activities that introduce the subject skill. Thus the educator-user can select, for the current lesson plan, a next development level (or appropriate development level) activity that addresses the skill. Or there may be several such next level activities for the educator-user to consider as displayed through curriculum data bank records 13. The educator-user can contemplate a series of lesson plans, each lesson plan utilizing a different one of those teaching activities from records 13, and each record offering an alternative implementation which may be more aligned with the subject student's learning style than the standard implementation as discussed above. The present invention data store of teaching activity records 13 in combination with student record information (e.g., lesson history, learning profile, etc.) 11 enables such student focused, individualized and customized planning of lessons.

In embodiments where a series of teaching activities/records 13 is defined per domain, then the assessment indications (per domain) in the student record 11 effectively provides a query into the respective activity series. The query results provide an indication of portion of the series of teaching activity records 13 that is appropriate for the current lesson plan in the making. Other query engines, rule engines and the like may be employed to determine appropriate curriculum records 13, for the current lesson being planned, as a function of student record 11 indications of assessed skill levels.

Further, lesson plans in one domain area for a given student do not unduly restrict or dictate lesson plans in another domain for that student. That is, the present invention allows flexibility between lesson plans and respective exercises (activities) of different domain areas per student. This is in recognition that learning disabled individuals (especially individuals with autism) often may learn skills in one domain area at a different rate than skills in other domain areas. Again, the present invention organizes student information in student records 11 and teaching activities of curriculum data store 13 by domain, core skill and skill level for purposes of enabling and guiding educators to form appropriate customized lesson plans for each student.

In other embodiments, curriculum records 13 provide audio-visual (video) demonstrations of the respective exercise. Other information or views of the corresponding exercise may also be provided and displayed upon selection by the educator-user.

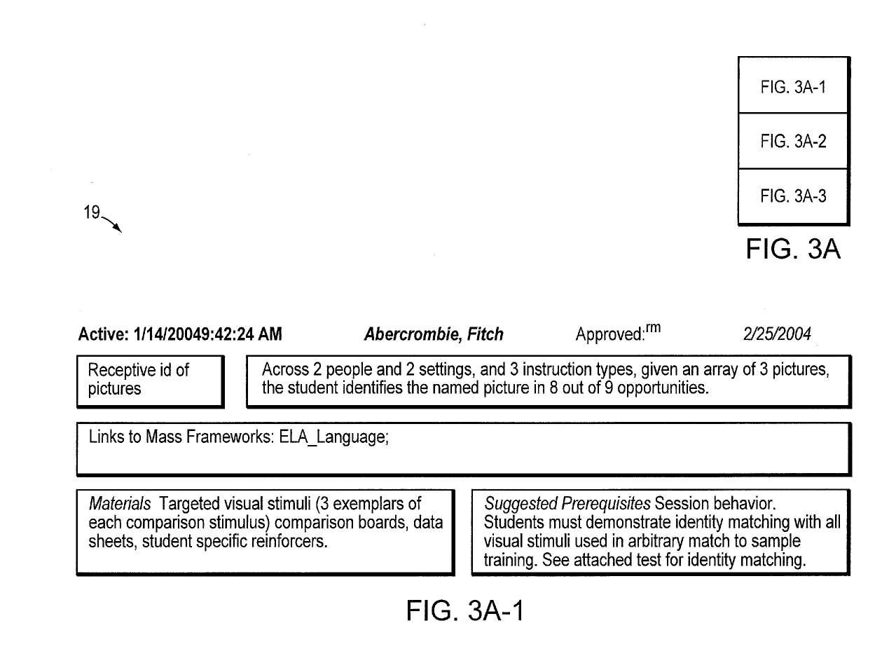

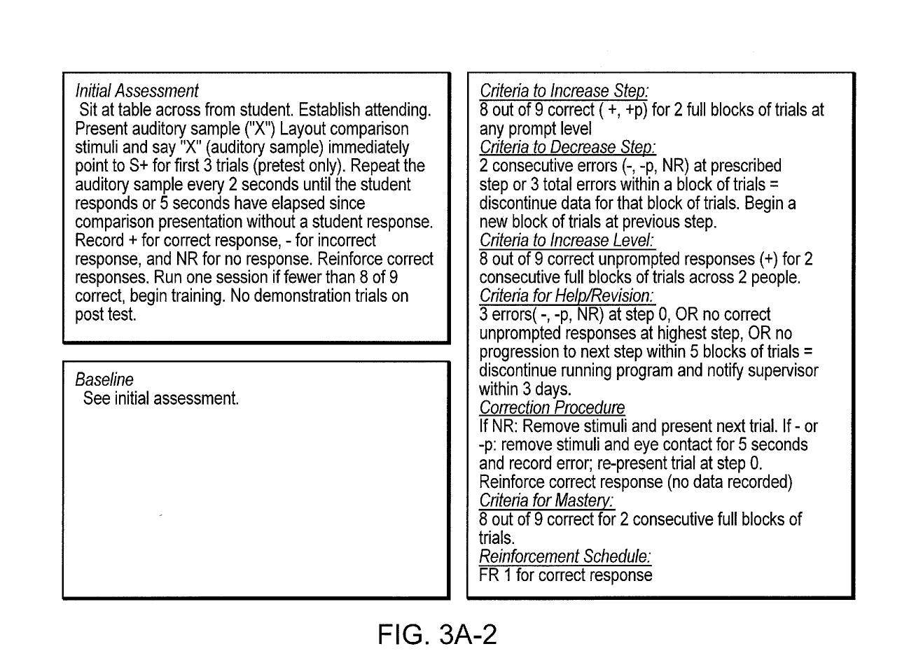

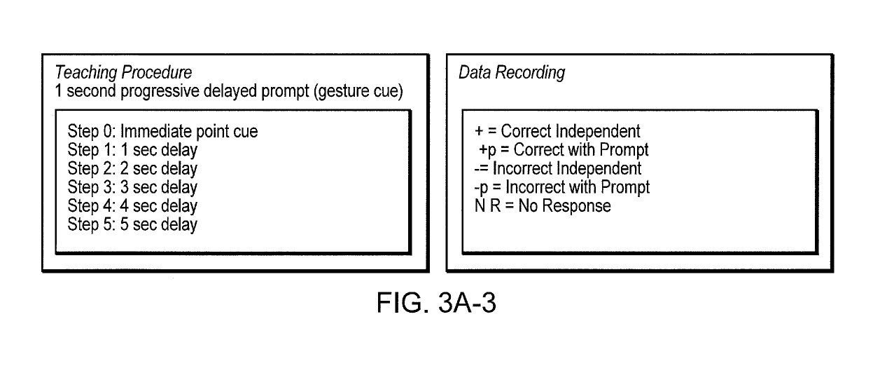

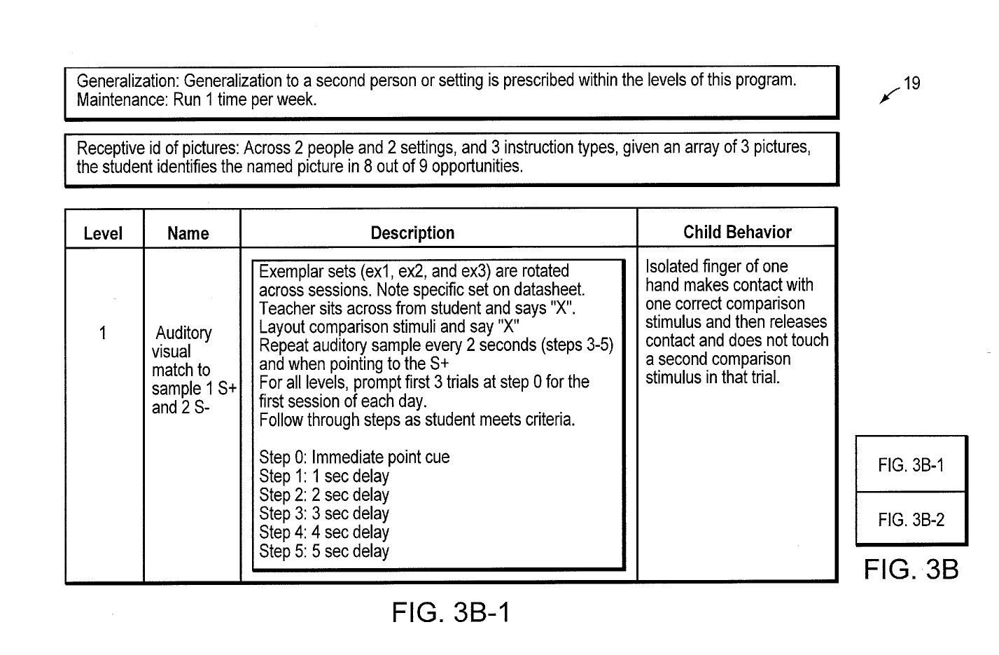

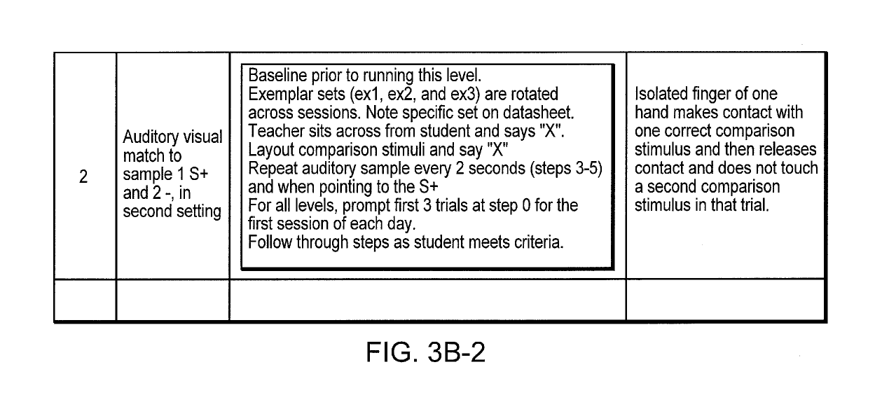

The user selected teaching activity unit/curriculum record 13 is copied to form an instructional template for the subject student (step 47). The educator-user may refine the formed instructional template knowing other lesson plans with respective activities are in progress (as indicated in student records 11). Once the educator-user is satisfied with the working instructional template 47, program 92 (step 49) is responsive to the educator-user command to output the custom made lesson plan. In the preferred embodiment, the output includes a custom curriculum sheet 19 designed for the educator to use during implementation of the custom lesson plan with the subject student. FIGS. 3a and 3b illustrate such a custom curriculum sheet 19 (detailed later).

It is understood that various decision support engines or subsystems may be employed. Such a subsystem would be responsive to user input at each step 41, 43, 45 and provide refined options for selection at a succeeding step based on information in curriculum records 13 and student records 11.

Referring to FIG. 4b, in step 35 the invention routine 92 may hold the custom made lesson plan (curriculum sheet 19) of step 49 for approval before output and use by the educator-user. An administrator-user, such as a supervisor, reviews the subject lesson plan through routine 92. Upon supervisor approval of the lesson plan (step 37), routine 92 releases the lesson plan and allows output of the curriculum sheet 19 to an educator-user for use as described above.

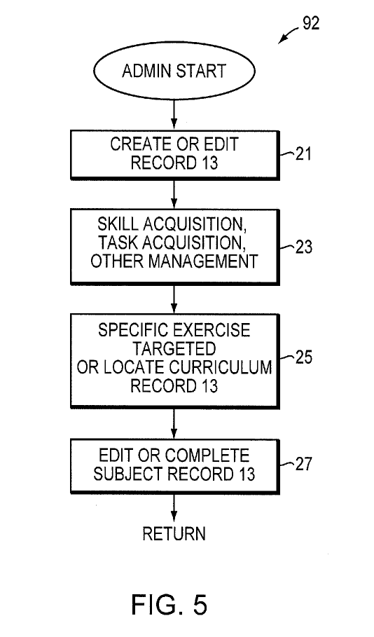

The prerequisites and criteria for the selected teaching activities in step 45 (FIG. 4a) are set in advance by content experts of the present invention as illustrated in FIG. 5. In the flow diagram of FIG. 5, the administrative user creates or edits records in the curriculum data bank 13 as follows. In step 21, the content expert selects to create or edit a curriculum (activity) record 13. In step 23, the user selects skill acquisition, task or other category of management/program administration. In step 25, the content expert selects or specifies teaching activity, in the selected category, for which he desires to define or edit the definition of. In step 27, the content expert edits or completes the record 13 of the subject teaching activity. This includes specifying the prerequisites, materials needed to implement the activity, alternative implementations and criteria for progressing with the activity or increasing or decreasing the level of the activity. Also in step 27 the content expert specifies cross references between the skill category (domain and/or core skill) for this teaching activity and other activities in the curriculum data bank records 13.

The foregoing settings are then reflected in screen views displayed (and output 19 rendered) to the teacher user in response to her utilizing the present invention system as described above in FIGS. 3a, b and 4a, b. As can be seen in the sample curriculum sheet 19 of FIGS. 3a and 3b, a day's lesson plan (with certain teaching activity) for the example student “Fitch Abercrombie” is provided. In the example, the curriculum sheet 19 specifies for the teacher materials required for the lesson and suggests prerequisites of the student. Initial assessment procedures as well as step-by-step activity instructions and procedure are also detailed on the curriculum sheet 19. “Grading” or marking instructions are also provided on the curriculum sheet 19, including criteria for increasing/decreasing step, criteria for help/revision, criteria for increasing level along with corresponding descriptions of each level and criteria for mastery.

Accordingly, a teacher (educator) generates different custom curriculum sheets 19 (i.e., lesson plans with teaching activities tailored to the student) for different skills to be introduced/practiced by a subject student. Collectively the many customized activity/curriculum sheets 19 form a custom student program. As such the present invention enables educators (teachers and administrators) to prepare custom lesson plans per student throughout a school or educational program. Further, where the lesson plans (past and current) are stored in connection with student records 11, the present invention enables various reporting of the same (especially with IEP reports). In a preferred embodiment, a reporter routine is coupled across invention program data 94 to gather fields of data necessary for IEP reports and to generate therefrom report documents in the necessary governmental or other agency formats. Other reports by groups of students, by particular curriculum (exercise or activity set), for performance, measured effectiveness and the like are made possible by the present invention student records 11 and curriculum records 13. Such data access, formatting and report generation are accomplished by known techniques in the art.

Where the invention program 92 is run on computers 50, 60 in communication with a global network 70, routine 92 allows linking to government agency websites for reporting student information and lesson plan data. Data gathering (uploading) to the student records 11 may be by remote wireless devices (e.g., hand held data communication devices) and the like. Other communications and network linking through invention 92 are also in the purview of one skilled in the art.

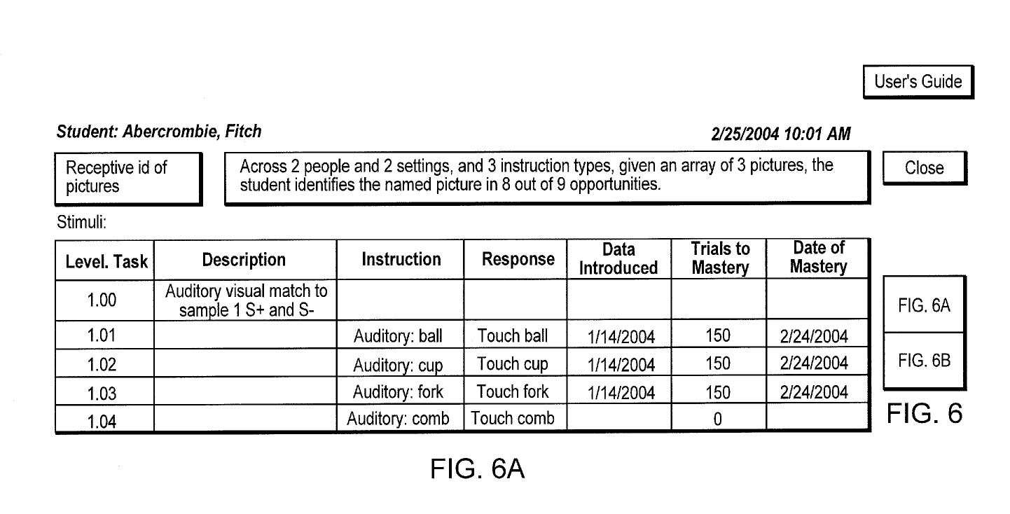

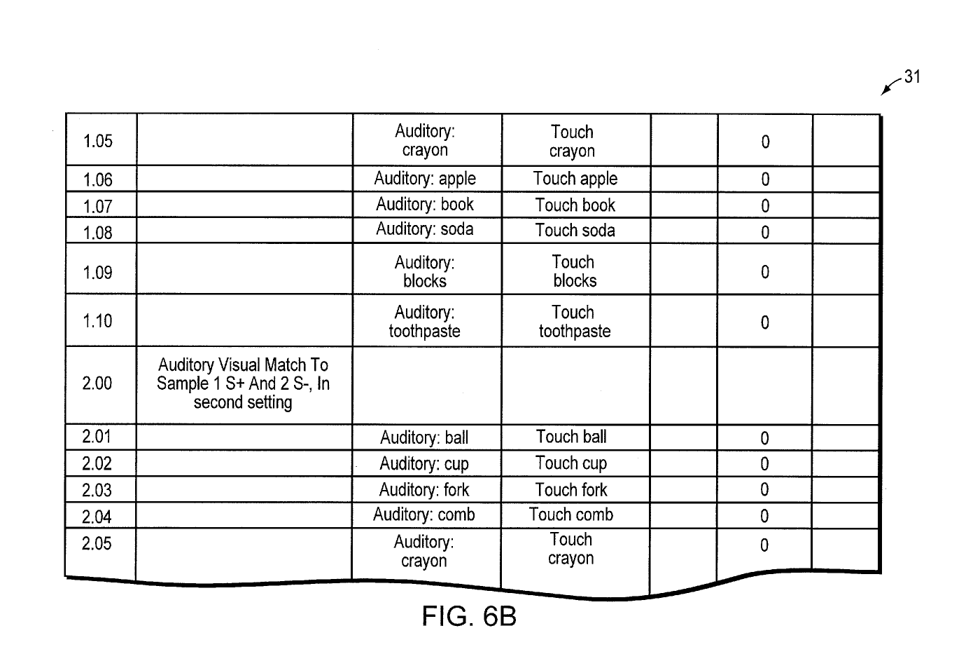

Another feature of the present invention system is that the progress or other reporting of performance of each lesson (implementation session) is enabled. As the teacher uses the generated curriculum sheet 19 to give a lesson, the teacher makes notes of the student's response. These responses are entered into the student record 11 (specifically at the current lesson section of the record 11). FIG. 6 illustrates the student record table 31 used in the preferred embodiment. This table 31 keeps a running tally of the student's trials, an indication of who taught the lesson, the date and time and location of the lesson, etc. Many of these aspects are factors in the learning pattern of an autistic student or a student with learning disabilities.

In the field of education for autistic students, this type of tracking of lessons is important. Autistic students do not adapt to changes well. Thus environment, teacher, location of the lesson, etc. impact learning and thus progress on each teaching activity or subject skill.

Administratively, student record table 31 may be used as a mechanism or point of process control in the invention system 92. For example, a home specialist or teacher may initially indicate that trials are being halted on a certain teaching activity or set of activities in table 31. System 92 responds by placing the corresponding lesson plan on hold 35 and pending approval loop as discussed in FIG. 4b. A supervisor and/or administrator may log onto this system 92 and review table 31. The administrator may then research or appropriately follow up on the surrounding circumstances to determine whether such halting is warranted. If so, the administrator and teacher alike may modify the student's lesson plan accordingly. Alternatively, system 92 may automatically trigger a notice to a supervisor/administrator after a predetermined number of trials have been halted and recorded as such in table 31. Other administrative controls can similarly be implemented through table 31 and the hold-approval loop of FIG. 4b.

In one embodiment, routine 92 provides a next lesson plan or curriculum sheet 19 for a given student based on the progression made within one teaching activity level and from one level to the next as documented in the corresponding student record 11 (e.g., table 31). As pertinent fields of table 31 are completed, routine 92 determines level of progress made by the subject student in the corresponding skill. Based on this determination and the ordering of teaching activities/records within the curriculum data bank 13 per domain and skill, routine 92 makes a preselection of next activity and level of activity and displays this in a proposed next lesson plan/curriculum sheet 19.

In certain embodiments, different educators from different areas of concern (e.g., occupational therapy, general scholastic, health, maintenance/hygiene, etc.) will use the invention tool to prepare custom lesson plans for the same subject student. The different skills domains and teaching activity levels of the present invention 92 are supportive of this team teaching approach which cannot be as effectively achieved in the prior art generic lesson plan making systems. Further, the cross-referencing of teaching activities or records within the curriculum data store 13 assists with the lesson planning by multiple teachers and monitoring by administrators.

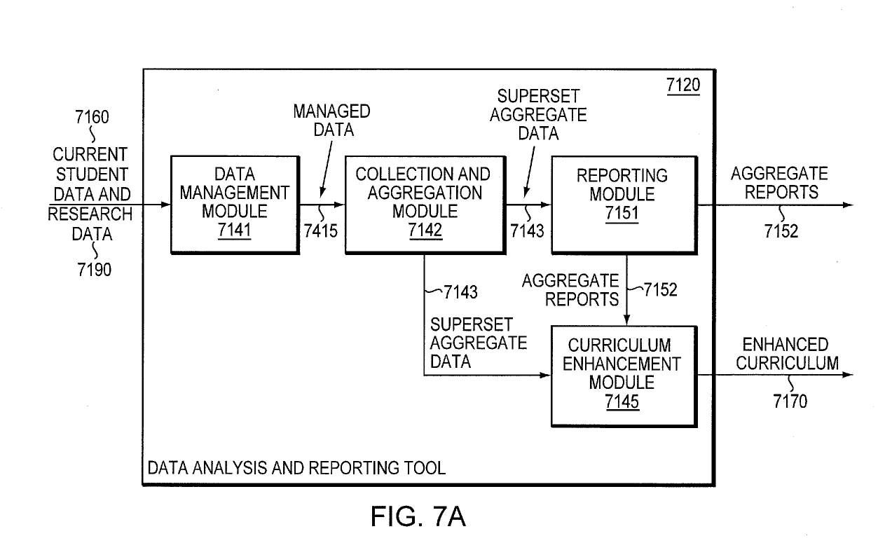

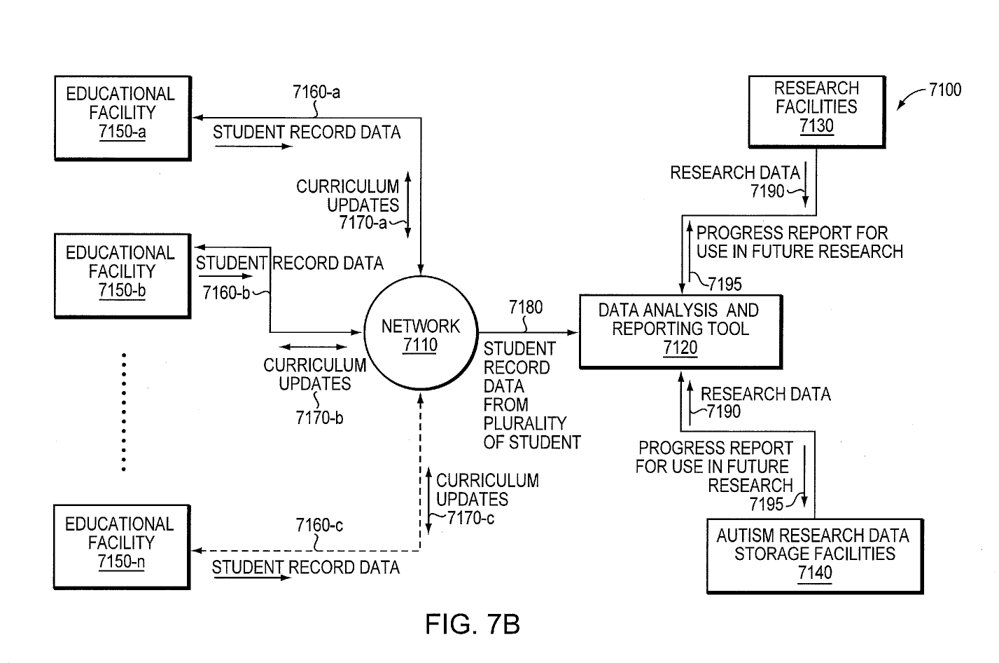

FIG. 7A illustrates a data analysis and reporting tool 7120 according to an example embodiment of the present invention. The data analysis and reporting tool 7120 includes a data management module 7141 that receives current student data 7160 and research data 7190 and outputs managed data 7415 (described later in relation to FIG. 4). A data collection and aggregation module 7142 employs the managed data 7415 and generates a superset aggregate data 7143. Known data structures and techniques are employed to aggregate the data, especially across categories of curriculum data 7310, student-course status data, personal student data 7340, teacher-student data 7350, student-group data 7360 and the like (further detailed later). The superset aggregate data 7143 may be used by a reporting module 7151 to generate aggregate reports 7152. The superset aggregate data 7143 and aggregate reports 7152 may be used by a curriculum enhancement module 7145 to create an enhanced curriculum 7170.

FIG. 7B is a high-level illustration of the data analysis and reporting tool 7120 according to an example embodiment 7100 of the present invention. The data analysis and reporting tool 7120 receives current student record data 7160-a, 7160-b and 7160-c from plurality of students 7180 via a network 7110 from educational facilities 7150-a, 7150-b, . . . , 7150-n. The current student record data from a plurality of students 7180 includes current student data 7160-a, 7160-b, . . . , 7160-n from respective individual students being educated or trained at the educational facilities 7150-a, 7150-b, . . . , 7150-n. The current student data 7160-a, 7160-b, . . . , 7160-n includes respective performance and progress data for each student. The educational facilities 7150-a, 7150-b, . . . , 7150-n may employ teaching techniques such as those suggested by Autism Curriculum Encyclopedia (ACE) of assignee. Additionally, student data may include student information and teaching activities for curriculums used for each students across various domain areas, such as communication, academics, social skills, leisure/recreation (generally fitness), vocational, self help, health and behavior to reduce. For each domain area, the current student data may include information regarding student's core set of skills, which are skills that are necessary for independent functioning of each individual student.

For example, for a given student, the current student data 7160-a may include the student's most recent set of skill in the communication domain (e.g., expressive language, expressive vocabulary, receptive language, receptive vocabulary, etc.), academics domain (e.g., math, spelling, reading, etc), self-help (e.g., domestic cleaning, hygiene maintenance skills, etc.), social skills domain (e.g., appropriate behavior, social interaction and reducing maladaptive behavior, etc.), and health domain (e.g., safety, growth and development and physical fitness, etc.).

The current student data 7160-a may also include the most recent student assessment data on the core set of skills per domain area. Often an initial assessment is performed and ongoing assessments are utilized to monitor a student's progress. Assessment results may include comments by parents, government worker input/feedback and the like in addition to educators.

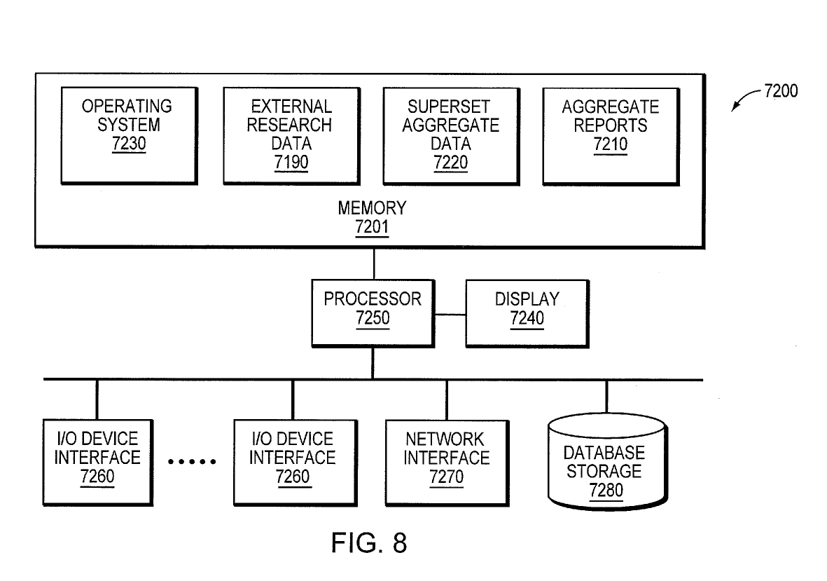

The data analysis and reporting tool 7120 may also receive research data 7190 from research facilities 7130 and autism research data storage facilities 7140. The data analysis and reporting tool 7120 may aggregate collected student data from the plurality of students 7180 over time and over various pluralities of students to generate a superset aggregate data 7220 (shown in FIG. 8).

In generating the superset aggregate data 7220, the data analysis and reporting tool 7120 may also employ available research data 7190. The superset aggregate data 7220 may be used to customize a curriculum for a given student and provide curriculum updates 7170-a, . . . , 7170-n for the given student. The data analysis and reporting tool 120 may also provide aggregate reports including performance and progress of the given student or the performance of the educational facility 7150-a, . . . , 7150-n.

Additionally, each educational facility 7150-a, . . . , 7150-n may employ a data bank (storage) of curriculum activities and lesson plans. These lesson plans and curriculum activities may be used by the data analysis and reporting tool 120 in generating customized (i.e., updated) curriculums 7170-a, . . . , 7170-n and/or providing progress reports for use in future research 195. The data bank of curriculum activities and lesson plans may be updated based on curriculum updates 7170-a, . . . , 7170-n received from the data analysis and reporting tool 7120.

The data analysis and reporting tool 7120 may also provide progress reports 7195 that can be used in future research to research facilities 7130 and research data storage facilities 140.

FIG. 8 is an example illustration of a management module that may be used with the techniques described herein.

The components of the management unit 7200 may be fully or partially placed in the data analysis and reporting tool 7120.

The management unit 8200 may include a memory unit 7201 along with a digital processor 7250 that may be connected to various interfaces via an input/output (I/O) device interfaces 7260. The memory unit 7201 may be a computer-readable memory and include combinations of non-volatile memory devices. The memory unit 7201 is configured to hold various computer-executable instructions and data structures including computer-executable instructions and data structures that implement aspects of the techniques described herein.

The memory unit 7201 may include units for procedures involved in determining and storing aggregate reports 7210, superset aggregate data 7220, and external research data 7190 according to example embodiments of the present invention.

The memory unit 7201 may also include an operating system 7230 and be arranged to implement various conventional operating system functions including task and process scheduling, memory management, and controlled access to various devices, such as a database storage unit 7280. The processes may include computer-executable instructions and data that are configured to implement various aspects of the techniques described herein.

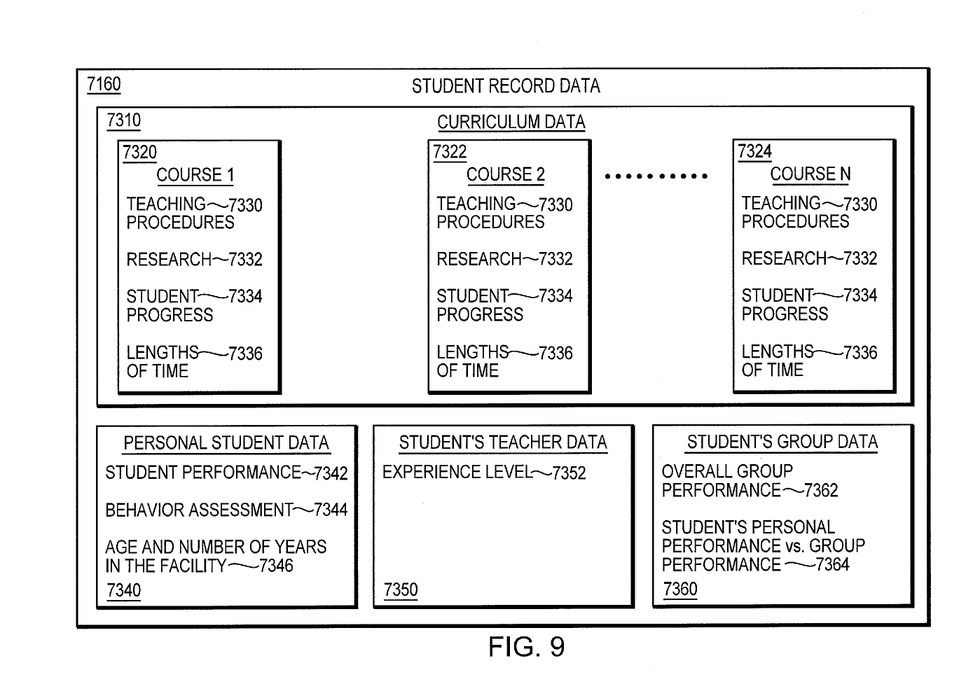

For example, data storage unit 7280 holds the managed data 7415 and superset aggregate data 7143. At least the superset aggregate data 143 is structured (indexed) by field categories of the student record data 7160 (i.e., curriculum data 7130, student-course status data, personal student data 7340, teacher-student data 7350, student-group data 7360 and so on as detailed in FIG. 9). Data storage may be implemented as a relational database for example.

The management unit 7200 may also include a network interface 7270 to connect the system to a network. The processor 7250 may include a conventional central processing unit (CPU) comprising processing circuitry that is configured to execute various instructions and manipulate data structures from the memory unit 7201.

The I/O device interfaces 7260 may include logic to interface various input and/or output devices, such as a keypad or mouse with the processor 7250. The I/O device interfaces 7260 may be configured to allow signals to be transferred between the management unit 7200 and other components of the system.

The management unit 7200 may include a display or other output unit 7240 to display, print, etc. aggregate reports 7210, enhanced curriculums 7170 (FIG. 1) and superset aggregate data 7220.

FIG. 9 is an illustration of student record data 7160 according to an example embodiment of the present invention. The student record data 7160 may include various elements for a given student such as curriculum data 7310, personal student data 7340, teacher data 7350, and group data 7360.

The curriculum data 7310 may include relevant data regarding the lessons, courses, or activities 7320, 7322, 7324 in the given student's curriculum. For each course, lesson, or activity 7320, 7322, 7324, the student record data may include information regarding teaching procedures 7330, research 7332, student progress 7334, and length of time 7336. The teaching procedures 7330 may include different sets of step-by-step instructions that have been or are being used in teaching a specific course, lesson, or activity to the given student. For example, teaching procedures 7330 may include steps required to teach a child to wash his/her hand.

For each course or activity 7320, 7322, 7324, relevant research information 7332 may also be included in the curriculum data 7310. For example, the research field 7332 in the hand-washing activity 320 (for example) may include recent teaching strategies developed and experimented for teaching a child to wash his/her hands. The teaching strategies may differ as a function of child-student abilities/skill level, learning preferences and/or other classification.

The student progress 7334 field includes information regarding the given student's progress such as grades, performance reports, and qualitative comments from instructors. Since students may often be a part of a group or team of students being educated/trained together, the student progress 7334 field may include reports of the given student's progress as compared to (relative to) other students in the group or team. On occasion, students are classified as being in beginner, intermediate, or advanced levels. In this case, the given student's progress field 7334 may include this classification.

Finally, the course data 7320, 7322, 7324 may include an indication of the length of time 336 the given student has been attending the course or lesson 7320, 7322, 7324. In effect, the curriculum data 7310 fields 7330, 7332, 7334, 7336 of information per course/lesson/activity 7320, 7322, 7324 provides student-course status for the given student.

The personal student data 7340 includes fields relating to student performance 7342, behavior assessment 7344, student's age, and number of years in the facility 7346. The student performance field 7342 may include information regarding the given student's overall performance, his engagement and interest in class activities, his participation in class activities, and his performance standing within a group of students. The student's performance field 7342 may include aggregate statistics regarding the given student's performance, grades, level, performance trends, and etc. over a period of time. The behavior assessment field 7344 may include information regarding the given student's functional behavior, overall behavior, specific behavior and responses to certain situations and behaviors that may later be reviewed to develop or revise a personalized/customized lesson plan. The personal student data field 7340 may also include the age (e.g., date of birth or age group) 7346 of the given student and the number of years the student has attended the present facility or similar educational facilities.

The given student's learning profile may also be included in personal student data 7340. The learning profile includes indications of student preferences (as observed by educators), learning patterns, past performance, techniques liked or disliked by the student and similar information, in general or per domain area. These aspects and indications are especially helpful in teaching individuals with autism or students with learning disabilities.

The student record data 7160 may also include a field regarding the given student's teacher (or teachers) 7350. The teacher data 7350 may include elements such as education, research interest and background, student reviews, parent reviews, experience level 7352, previous classes taught, previous review and feedback received, performance reviews, resume, years worked at the current facility, employment details, progress of his/her students, and etc. The student's teacher data 7350 may also include aggregate statistics regarding teacher's performance, grade distribution, and etc. over a predetermined length of time.

The student record data 7160 may also include, for a given student, information regarding teachers involved in teaching that student. Similarly, for a given teacher, the student record data 7160 may include progress data for students of that teacher.

The student record data 7160 may also include a field regarding a student's group. Since, occasionally, students are being trained within groups, the student's group data 7362 may include data regarding overall group performance 7362 as well as the given student's personal performance as compared to the group performance 7364.

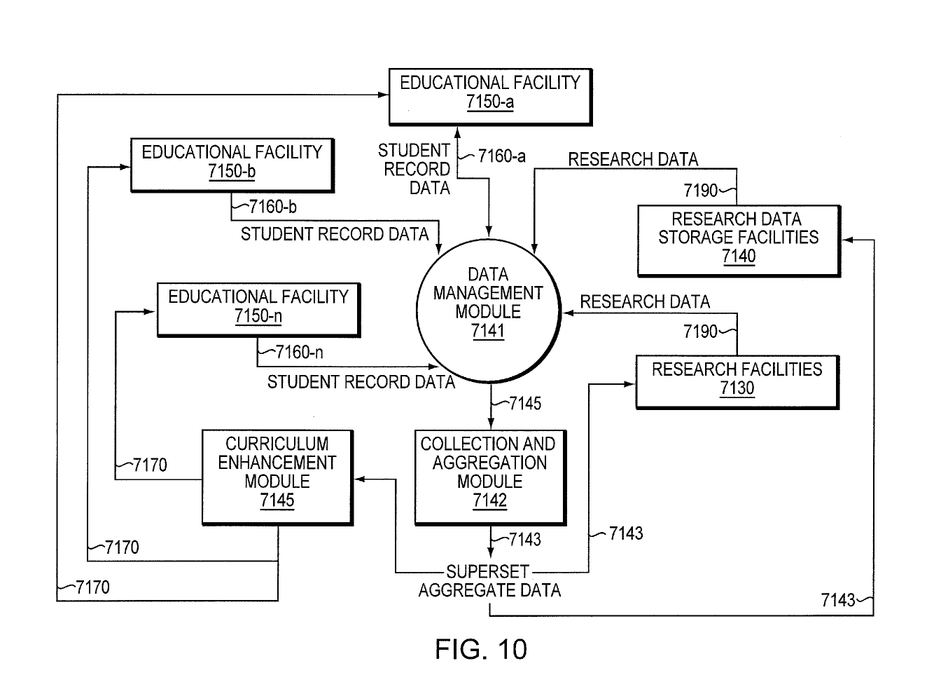

FIG. 10 is a high-level illustration of a data management module 7141 and a data collection and aggregation module 7142 according to an example embodiment of the present invention. The data management module 7141 receives, collects, synthesizes, and contemplates current student data 7160-a, . . . , 7160-n from educational facilities 7150-a, . . . , 7150-n and generates managed data 7415. Known data collection and management techniques are employed. The data management module 7141 may collect student record data 7160-a, . . . , 7160-n from various educational facilities 7150-a, . . . , 7150-n at various geographical locations across the globe. The data management module 7141 may also receive research data 7190 from research facilities 7130 and research data storage facilities 7140. The data managed by the data management module 7141 may be already in electronic format. Alternatively, the data may be in the form of hand-written reports, printed images and reports, audio, and etc. The data management module 7141 may employ tools known in the art to digitize, normalized, synchronize, or standardize its received data 7160-a, . . . , 7160, 7190.

The managed data 7415 is collected and aggregated by the data collection and aggregation module 7142 to generate a superset aggregate data 7143. The data collection and aggregation module 7142 may employ statistics such as averages, medians, percentiles across all data or sections of data in creating the superset aggregate data 7143. Additionally, the data collection and aggregation module 7142 may determine the superset aggregate data 7143 across cross sections or portions of managed data 7415 based on factors such as student geographic locations, schools, geographical locations of the schools, school characteristics such as publicly funded or privately funded school, student characteristics such as age, gender, parent income level, educator salaries, and etc. The data collection and aggregation module 7142 may prepare the superset aggregate data 7143 in a tabular format in preparation for charting and visual display or in other audio and/or visual formats for future reporting and display purposes by the reporting module 7151 (FIG. 7A). Common or known technologies are employed by the data collection and aggregate module 7142.

The superset aggregate data 7143 may be transmitted to the research facilities 130 and/or research data storage facilities 7140 for future use in research or data aggregation.

The superset aggregate data 7143 may be used in the curriculum enhancement module 7145 to generate an enhanced curriculum 7170 for one or more students. The enhanced curriculums are transmitted to the educational facilities 7150-a, . . . , 7150-n, where they are used in updating teaching activities/courses/lessons 7320, 7322, 7324/step-by-step instructions/props (audio visual teaching tools)/and the like for one or more students.

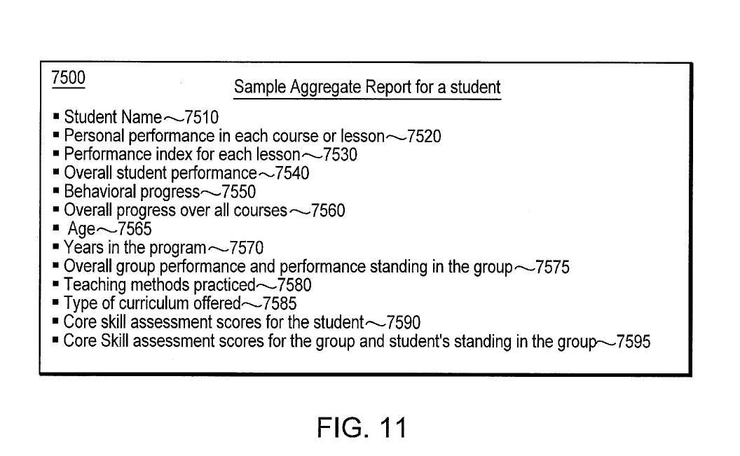

FIG. 11 is an example embodiment of a sample aggregate report 7500 for a given student. The report 7500 is illustrative of aggregate reports 7152 and by reporting module 7151 in FIG. 7A. The sample aggregate report 500 may include elements such as student name 7510, personal performance 7520 in each course or lesson 7320, 7322, 7324, performance index 7530 for each lesson 7320, 7322, 7324, overall student performance 7540, behavioral progress 7550, overall progress over all courses 7560, student age 7565, years in the program 7570, overall group performance and performance standing in the group 7575, teaching methods practiced 580, type of curriculum offered 7585, core skill assessment scores for the given student 7590, and core skill assessment scores for his group and student's standing in the group 7595.

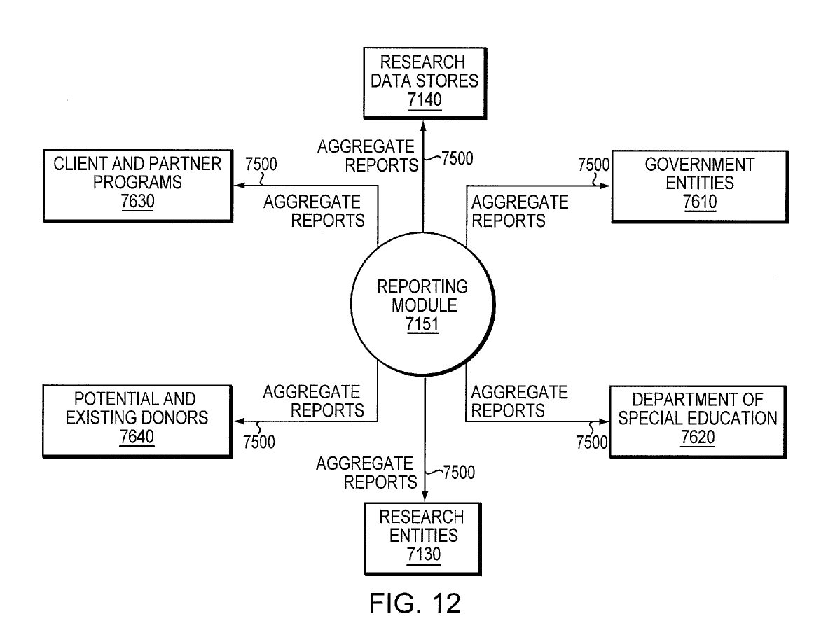

FIG. 12 is a high-level illustration of the reporting module 7151 according to an example embodiment of the present invention. The reporting module 7151 may report the superset aggregate data 7143 in a variety of forms, including a graphic model, text model, audio and/or video model. An example of the graphic model is the case of charts displaying past and/or present performance reports based on current student data for a plurality of students in various sets/subsets (by age, number of years in program, geographic location of student residence, geographic location of school facility, teacher group, etc.). Known data reporting techniques are employed. The reporting may be done via a default reporting program application and/or a Graphical User interface. The reporting module 7151 may generate aggregate reports 7500 for future use in various entities such as research entities 7130, department of special education 7620, government entities 7610, research data storage facilities 7140, clients and partner programs 7630, and potential and existing donors 7640.

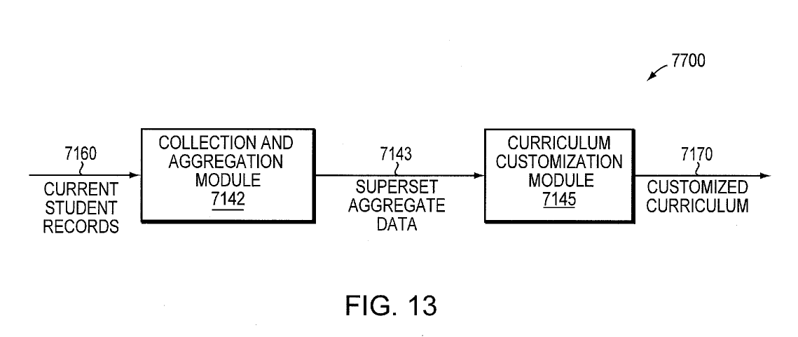

FIG. 13 is a high-level illustration of a computer system 7700 for customizing a curriculum of a given student. The computer system 7700 includes the collection and aggregation module 7142 in computer memory. The collection and aggregation module 7142 is configured to collect current student record data 7160 of a plurality of students. The student record data 7160 includes recent performance and progress data for each student. The collection and aggregation module 7142 is configured to aggregate the collected student record data over time and over various pluralities of students to generate a superset aggregate data 7143. A curriculum customization module 7145 (also referred to as a curriculum enhancement module 7145) is configured to receive the superset aggregate data 7143 from the collection and aggregation module 7142 and customize a current curriculum 7170 (also referred to as enhanced curriculum 7170) for the given student as a function of the performance patterns or trends, including a single achievement by a similar (like classification) student, shown by/in the superset aggregate data 7143.

For example, for two individual students, student A and student B, being trained at an educational facility. The current student data for the two students (i.e., student A and student B) is collected in the superset aggregate data. Student A and student B may have some categories of similarity as shown in aggregate student reports 7152 and superset aggregate data 7143. The curriculum enhancement module 7145 may employ the superset data 7143 to determine an enhanced and customized curriculum for the students. In an event the curriculum enhancement module 7145 determines that certain enhancements to the curriculum of a student (e.g., student A) are required, similar enhancement may be applied to the curriculum of a similar student (e.g., student B).

Certain example embodiments may track performance rate (e.g., rate of skill acquisition) for various students, including student A and student B, and report the performance rate to entities such as government entities 7610, department of education 7620, research facilities 7140. The performance rate may in turn be used to develop changes in teaching methods used for a given student.

Certain embodiments may use a “user-centric” approach in its analysis and design by putting emphasis on defining the different users and their characteristics. The embodiment may identify major problem areas within the current PRODUCT usability, navigation, workflow, overall layout.

In some embodiments, focus groups including multiple educator-users including our senior management, teachers, specialists, other stakeholders, external users, and non-users may be formed to identify scenarios, features and workflows that may improve usability, navigations, overall layout and overall workflow. The team may create wireframes and layouts for the user interface with prototypes of the new data flows, user model, and metaphors.

Certain embodiments may be redesigned leverage its content and create more business opportunities. Additional functionality including a data management system for recording Challenging Behavior and Protective Measures may be added. This functionality may assist users in defining and measuring behaviors that interfere with learning and independent performance. It may also allow the users to document and track procedures used to decrease rates of challenging behavior. A protocol for assessing student preferences may be added to the assessment functionality of the embodiments. This functionality may allow users to access step by step instructions for identifying and tracking items which may serve as motivators for students as they learn new skills. Further, Core Skill Assessment may be updated based on data and user feedback and a simplified version of the existing lesson plans may be generated.

Some embodiments may employ videos that demonstrate commonly used teaching procedures for the lesson plans. Further videos that demonstrate portions of the Core Skills Assessment may be used. As new lesson plans and assessments are added, additional videos may be added.

To deal with the variation of reports, such as “IEP,” within and across programs, school systems, and states, certain embodiments may provide reports on student performance for all objectives targeted and employ these reports to write current performance and progress information in whatever type of state reporting documents are required. In this way, embodiments of the invention give internal and external users the tools to create reports, rather than attempt to create every type of report (such as IEP).

Certain embodiments may create a student schedule based on the active lessons plans chosen for each student or group of students. Further, some embodiments may offer curriculum modifications to a group of curriculum or group of students since often times a teaching procedure is identified for a particular student which should be applied to a number of active curriculum.

Additional component may be added to each curriculum sheet to provide a guide for evaluating performance problems and suggest strategies for improving performance and/or a link to remedial curricula.

Certain embodiments may link the lesson plans and assessments to published research literature. This feature may allow the user access to additional information on the procedures outlined herein.

A new teaching template may be added to guide users in providing instruction to a group of students. This template may provide assessment, lesson plans, and data systems to program for students ready to learn in larger groups.

In some embodiments, expanded skills assessment may be utilized. This is an expansion of the Core Skills Assessment. Given this functionality, users may have access to a protocol for identifying and assessing entry skills beyond the core or foundation skills.

Certain embodiments may allow uploading of documents to student. Examples include lists of words, pictures of stimuli (related to classroom or home), and additional worksheets.

In some embodiments a parent portal may be utilized. This may allow Parents to see the curriculum and process reports for the child. It may also help improve communication with Parents and provide links to social media systems to aid in parent to parent discussions.

In some embodiments, a recommendation engine may be utilized to calculate next steps for teachers, based on data entered from previous session.

Portable Devices may be used to give the ability to enter data faster and easier and facilitate better reporting and data Analysis. For example, mobile device and scanning sheets may be used as a part of the education environment. Enabling data entry from and mediums, such as i-pod and/or blackberry, may facilitate faster data entry. Not all schools have the financial capability to purchase these mobile devices, so scanning sheets may be used to help these schools. The scanning sheets may allow the data to be entered via scanning the sheet into a scanner of manually entered into the system.

Certain embodiments may employ learner profile assessment to guide the user in identifying the most effective teaching procedure for any given student.

Further a commercial curriculum may be developed to help integrate the use of commercial curriculum onto the embodiments.

In some embodiments, when the location of the school and/or student does not allow for internet connection, off-line access may be provided. Having an off-line version will allow the application to be used and data to be entered. When the teacher is at to a location with internet access, the data may be synched to the live system and data analysis can begin.

As the technology and the security of public cloud improve and the user base continues to grow, embodiments of the invention may be moved to a public platform. Leveraging public cloud technology may reduce our hardware cost and improve global connectivity.

Embodiments of the invention may be created in various languages to allow global utilization.

It should be understood that procedures, such as those illustrated by flow diagrams or block diagrams herein or otherwise described herein, may be implemented in the form of hardware, firmware, or software. If implemented in software, the software may be implemented in any software language consistent with the teachings herein and may be stored on any computer readable medium known or later developed in the art. The software, typically, in form of instructions, can be coded and executed by a processor in a manner understood in the art.

While this invention has been particularly shown and described with references to example embodiments thereof, it will be understood by those skilled in the art that various changes in form and details may be made therein without departing from the scope of the invention encompassed by the appended claims.

What is claimed is:

1. A computer system for customizing a curriculum of a student comprising:
a collection and aggregation module in computer memory, the collection and aggregation module configured to collect current student record data of a plurality of students, the student record data including recent performance and progress data for each student, and the collection and aggregation module configured to aggregate the collected student record data over time and over various pluralities of students to generate a superset aggregate data;
a curriculum customization module configured to receive the superset aggregate data from the collection and aggregation module, the curriculum customization module customizing a current curriculum for a given student as a function of the superset aggregate data.

2. The computer system of claim 1 wherein the collection and aggregation module is configured to collect the current student record data at predetermined time intervals.

3. The computer system of claim 1 wherein the collected student record data includes at least one of curriculum data, student course status data, personal student data, teacher data, and group data.

4. The computer system of claim 3 wherein the student course status data includes at least one of teaching procedures, research data, student progress, and time elapsed since application of a teaching procedure.

5. The computer system of claim 3 wherein the personal student data includes at least one of student's performance, behavior assessment, skill assessment and age.

6. The computer system of claim 3 wherein the teacher data includes experience level.

7. The computer system of claim 3 wherein the group data includes at least one of group performance and student's personal performance versus group performance.

8. The computer system of claim 1 further including a data module configured to collect research data and update the superset aggregate data as a function of the collected autism research data.

9. The computer system of claim 1 further including a reporting module coupled to the memory, the reporting module configured to generate data reports for the student.

10. The computer system of claim 1 wherein the curriculum customization module customizes the curriculum for the given student as a function of updating teaching procedures used.

11. The computer system of claim 1 further including a synchronization module configured to synchronize the superset aggregate data with autism research data.

12. The computer system of claim 11 wherein the synchronization module is configured to generate synchronized student record data as a function of synchronizing the current student record data with the superset aggregate data.

13. A method for customizing a curriculum of a student comprising:
collecting current student record data of a plurality of students in computer memory, the student record data including recent performance and progress data for each student;
aggregating the collected student record data over time and over various pluralities of students to generate a superset aggregate data;
customizing a current curriculum for a given student as a function of the superset aggregate data.

14. The method of claim 13 further including collecting the student record data at predetermined time intervals.

15. The method of claim 13 wherein the collected student course status data includes at least one of curriculum data, student record data, personal student data, teacher data, and group data.

16. The method of claim 15 wherein the student course status data includes at least one of teaching procedures, research data, student progress, and time elapsed since application of a teaching procedure.

17. The method of claim 15 wherein the personal student data includes at least one of student's performance, behavior assessment, skill assessment and age.

18. The method of claim 15 wherein the teacher data includes experience level.

19. The method of claim 15 wherein the group data includes at least one of group performance and student's personal performance versus group performance.

20. The method of claim 13 further including collecting research data and updating the superset aggregate data as a function of the collected research data.

21. The method of claim 13 further including generating data reports for the student.

22. The method of claim 13 further including customizing the curriculum for the given student as a function of updating teaching procedures used.

23. The method of claim 13 further including synchronizing the superset aggregate data with autism research data.

24. The method of claim 23 further including generating synchronized student record data as a function of synchronizing the current student record data with the superset aggregate data.
